(19) United States
(12) Patent Application Publication
(10) Pub. No.: US 2006/0200334 A1
(43) Pub. Date: Sep. 7, 2006

(54) Method of predicting suitability for a soil engaging operation

(75) Inventors: Steven Michael Faivre, Kingston, IL (US); Mark William Stelford, Sycamore, IL (US); Terence Daniel Pickett, Waukee, IA (US)

Correspondence Address: DEERE & COMPANY, ONE JOHN DEERE PLACE, MOLINE, IL, 61265, US

(73) Assignee: Deere & Company, a Delaware corporation

(21) Appl. No.: 11/074,174

(22) Filed: Mar. 7, 2005

(51) Int. Cl. G06F 9/45

(52) U.S. Cl. 703/22

(57) ABSTRACT

Presented herein is a method for predicting suitable times for performing a soil engaging operation within a field. The method includes the steps of accessing predicted values for weather and soil conditions, and then predicting values for one or more operation variables indicating operation suitability. The method then predicts suitability for performance of the soil engaging operation based on the predicted operation variables and selected suitability parameters.

### FIELD OF THE INVENTION

The present invention relates to the prediction of soil conditions and assessment of suitability for performance of a soil engaging operation.

### BACKGROUND OF THE INVENTION

Land suitable for uses such as transport, agriculture, or construction are subjected to a number of soil engaging operations. In order to optimize performance of these operations for efficiency, crop performance, and/or minimal impact on the soil, it is critical that operations be performed when weather and soil conditions are suitable. In order to aid in planning, a method of predicting suitable times for performing a number of different soil engaging operations is desirable.

### SUMMARY OF THE INVENTION

Presented herein is a method for predicting suitable times for performing a soil engaging operation. The method includes the steps of accessing predicted values for weather and soil conditions, and then predicting one or more values for soil characteristics, operation characteristics, and operation effects. Based on these predicted operation variables and selected suitability parameters, the method predicts operation suitability for different points in time.

### BRIEF DESCRIPTION OF THE DRAWINGS

FIG. 1 illustrates a farm field having many field nodes.

FIG. 2 illustrates a first embodiment for the present invention method.

FIG. 3 illustrates a second embodiment for the present invention method.

FIG. 4 illustrates a table displaying suitability values for performance of a soil engaging operation at a single field node on a single day.

FIG. 5 illustrates a map displaying suitability values for performance of a soil engaging operation over a single field on a single day.

FIG. 6 illustrates a graphical displaying suitability values for performance of a soil engaging operation over a single field for multiple days.

FIG. 7 illustrates a graphical displaying suitability values for performance of a soil engaging operation over multiple fields on a single day.

### DETAILED DESCRIPTION

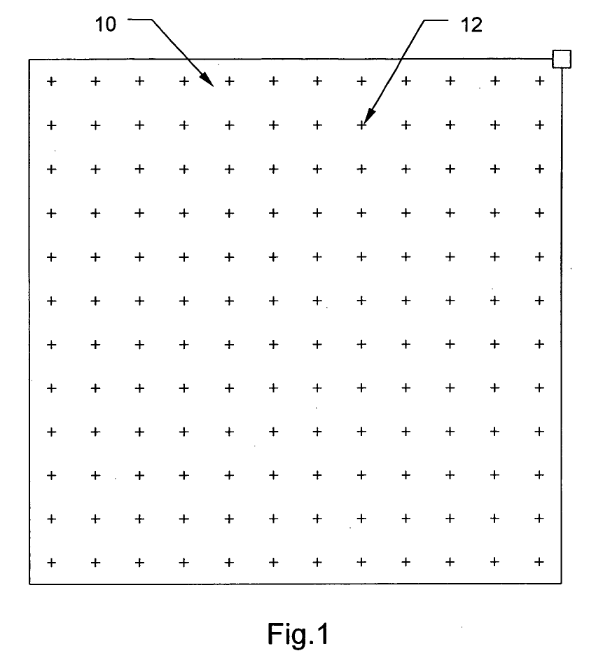

FIG. 1 illustrates a parcel of land, or field 10, suitable for soil engaging uses such as transport, agriculture, or construction. It is important to note that the present invention may be applied to all such uses, but for illustration purposes the parcel is illustrated here as a farm field under agricultural cultivation. As such, the field 10 is subject to soil engaging operations such as tillage, planting, harvesting, transport, and human or animal foot traffic. Numerous field nodes 12 dispersed throughout field 10 divide the parcel into smaller sample areas. A method presented herein predicts suitability 6 for performing such operations in the field 10 at different points in time, based on operation variables 8 predicted for each field node 12.

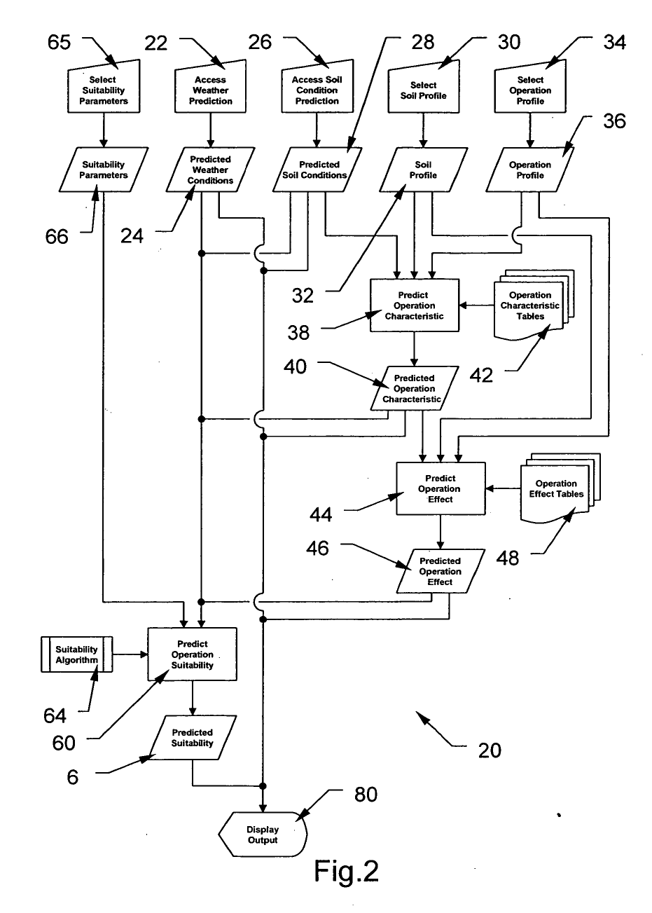

FIG. 2 illustrates a first embodiment 20 of the present invention whereby the method predicts operation variables 8 indicative of operation performance suitability 6 at field node 12. The first step 22 in this embodiment 20 is to access values predicted for weather conditions 24 at the node 12. These predicted weather conditions 24 include values for, but are not limited to, temperature, relative humidity, wind speed, precipitation, and solar radiation. Values for these conditions 24 can be obtained from sources such as the National Weather Service website, operated by the National Oceanic and Atmospheric Administration.

The second step 26 in this embodiment 20 is to access values predicted for soil conditions 28 at the node 12 at different points in time. These conditions 28 include, but are not limited to, soil moisture and soil temperature. To predict values for soil conditions 28, the method may use a dynamic soil model, such as the Precision Agricultural-Landscape Modeling System (PALMS) developed under NASA's Regional Earth Science Application Center (RESACA) program. This program predicts soil moisture and soil temperature, as well as crop moisture and other variables, based on predicted weather conditions and measured soil conditions. This computer program is available under license for research or commercial use through the Wisconsin Alumni Research Foundation.

The third step 30 in this embodiment 20 is to select a soil profile 32 representative of the field node 12. A soil profile 32 describes a particular soil for which empirical tests have been conducted for this method 20. A soil profile 32 includes information such as soil type and composition, down to several feet. The fourth step 34 is to select an operation profile 36 representative of the soil engaging operation to be performed. An operation profile 36 describes a particular operation for which empirical tests have been conducted for this method 20. Operation profiles 36 include parameters such as operation type, equipment size, machine configuration, and operation speed. The operation profile 36 might also include additional parameters such as crop species and fuel price.

The fifth step 38 in this embodiment 20 is to predict operation characteristics 40 that are resultant upon performance of the operation under the predicted soil conditions 28. Operation characteristics 40 are generally indicative of operation suitability 6, and include, but are not limited to, soil compaction impact (A compaction), soil particle size, tractive efficiency, and fuel consumption. In the illustrated embodiment 20, these operation characteristics 40 are determined by referring to empirical tables 42 giving values for known soil conditions 28, soil profile 32, and operation profile 36. For example, a table 42 giving values for A compaction may be developed by performing the soil engaging operation under a number of soil moisture conditions on a test plot having a consistent soil composition. The parameters of the operation performed define the operation profile 36, and the composition of the test plot soil defines the soil profile 32.

The sixth step 44 in this embodiment 20 is to predict operation effects 46 that are resultant upon performance of the operation, given the predicted operation characteristics 40. Operation effects 46 are also indicative of operation suitability 6, and include, but are not limited to, crop yield impact and fuel cost. In the illustrated embodiment 20, these effects 46 are determined by referring to empirical tables 48 giving values for known operation characteristics 40, soil profile 32, and operation profile 36. For example, a table 48 giving values for crop yield impact may be developed by measuring crop yields under a number of soil compaction levels on a test plot having a consistent soil composition. Examples outlining the development of such tables 48 may be found in Soybean Growth and Yield as Affected by Subsurface and Subsoil Compaction, J. F. Johnson, et al., Agronomy Journal, Vol. 82, No. 5, September-October 1990.

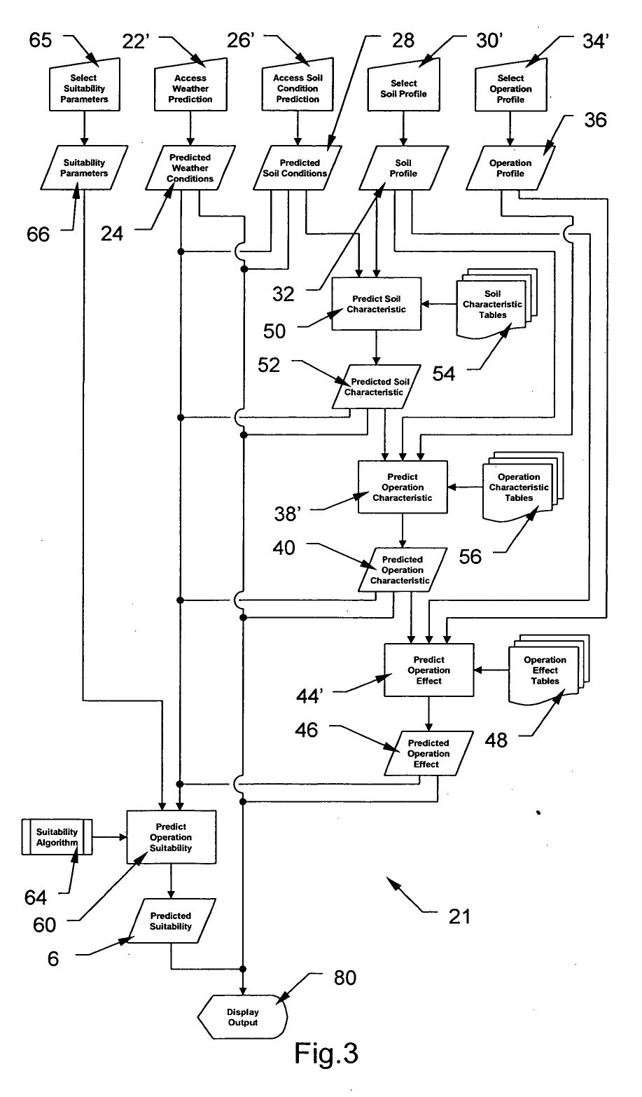

FIG. 3 illustrates a second embodiment 21 of the present invention whereby the method predicts operation variables 8 indicative of operation performance suitability 6 at a node 12 within the field 10. The first step 22′ in this embodiment 21 is to access values predicted for weather conditions 24 at the node 12, like the first embodiment 20. The second step 26′ in second embodiment 21 is to access values predicted for soil conditions 28 at the node 12 at different points in time, like the first embodiment 20. The third step 30′ in this embodiment 21 is to select a soil profile 32 representative of the field node 12, like the first embodiment 20.

The fourth step 50 in this embodiment 21 is to predict values for soil characteristics 52 for a soil under known soil conditions 28. The soil characteristic 52 of particular interest in this embodiment is Atterberg Limits. These soil characteristics 52 are determined in the illustrated embodiment 21 by referring to empirical tables 54 giving values for known soil conditions 28 and soil profile 32. These tables 54 may be generated by performing tests under a number of soil moisture conditions on specimens of soil profiles 32 according to ASTM D 4318-00: Standard Test Method for Liquid Limit, Plastic Limit, and Plasticity Index of Soils.

The fifth step 34′ in this embodiment 21 is to select an operation profile 36 representative of the soil engaging operation. The sixth step 38′ in this embodiment 21 is to predict operation characteristics 40 that are resultant upon performance of the operation, given the predicted soil characteristics 52. In the illustrated embodiment 21, these operation characteristics 40 are determined by referring to empirical tables 56 giving values for known soil characteristics 52, soil profile 32, and operation profile 36. For example, a table 56 giving tractive efficiency and fuel consumption may be developed empirically by performing the soil engaging operation under a number of Atterberg Limit conditions.

The seventh step 44′ in this embodiment 21 is to predict operation effects 46 that are resultant upon performance of the operation, given the predicted operation characteristics 40, in the same manner as the first embodiment 20. Alternatively, the method in this embodiment 21 may determine these operation effects 46 by calculating values based on predicted operation characteristics 40 and operation profile 36. For example, multiplying fuel consumption, an operation characteristic 40, by fuel price, an operation profile 36 parameter, predicts fuel cost for the operation.

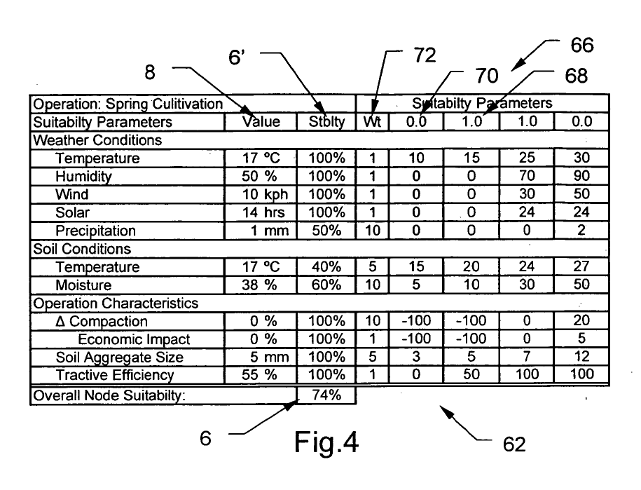

The final step 60 of both the first embodiment 20 and second embodiment 21 is to predict operation suitability 6 at the node 12 for several points in time based on the predicted values for the operation variables 8. For clarity, the operation variables 8 include weather conditions 24, soil conditions 28, soil characteristics 52, operation characteristics 40, and operation effects 46. FIG. 4 illustrates a table 62 showing input and output for an operation suitability algorithm 64. By selecting suitability parameters 65, the suitability algorithm 64 calculates suitability values for each operation variable 6 based on the corresponding suitability parameters 66. These parameters 66 define thresholds at which the variable is suitable 68 for the soil engaging operation, and thresholds beyond which the variable is unsuitable 70.

For example, if a value for an operation variable 8 at a given point in time falls within the suitable value thresholds 68, then the suitability value 6′ for that operation variable 8 is 100%. Conversely, if the value for the variable 8 falls outside of the unsuitable value thresholds 70, then the suitability value 6′ for that operation variable 8 is 0%. Finally, if the value for the operation variable 8 falls within the transition range between suitable and unsuitable thresholds, then the suitability value 6′ for that operation variable 8 is the fraction between the suitable threshold value 68 and unsuitable threshold value 70. FIG. 4 illustrates an example, with suitability parameters 66 for soil temperature having a suitable lower threshold value of 20 degrees, and an unsuitable lower threshold value of 15 degrees. Thus, for the predicted soil temperature of 17 degrees, the suitability value 6′ for soil temperature calculates as ((17−15)/(20−15))×100=40%.

As illustrated, the suitability 66 parameters also include weightings 72 emphasizing relative importance of the operation variables 8 in assessing overall operation suitability 6 for the node 12. The suitability algorithm 64 calculates overall suitability 6 by multiplying each operation variable suitability value 6′ by its corresponding weighting 72 for a weighted suitability value, then dividing the sum of the weighted suitability values by the sum of the weighting values 72. FIG. 4 illustrates an example of overall node suitability 6 for performance of a soil engaging operation, based on predicted weather conditions 24, soil conditions 28, and operation characteristics 40.

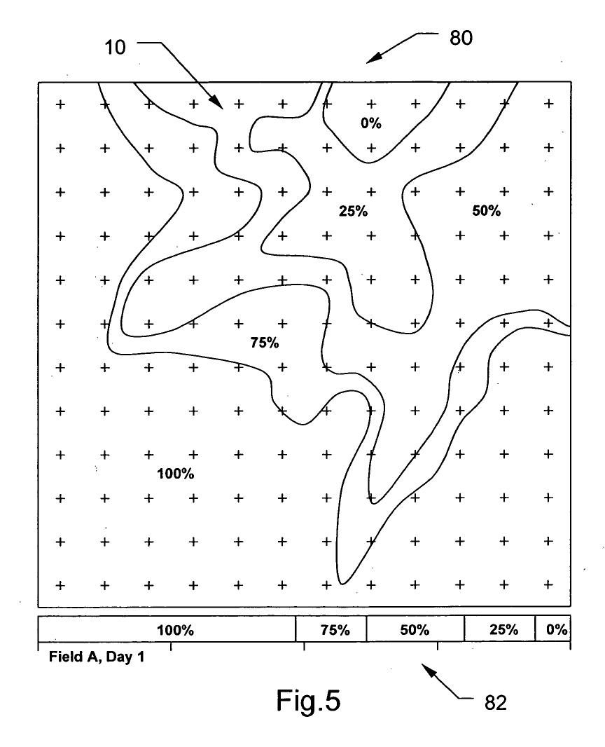

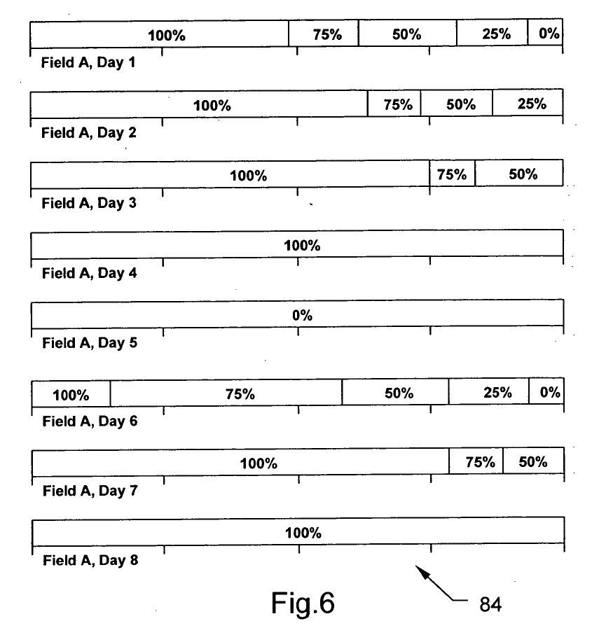

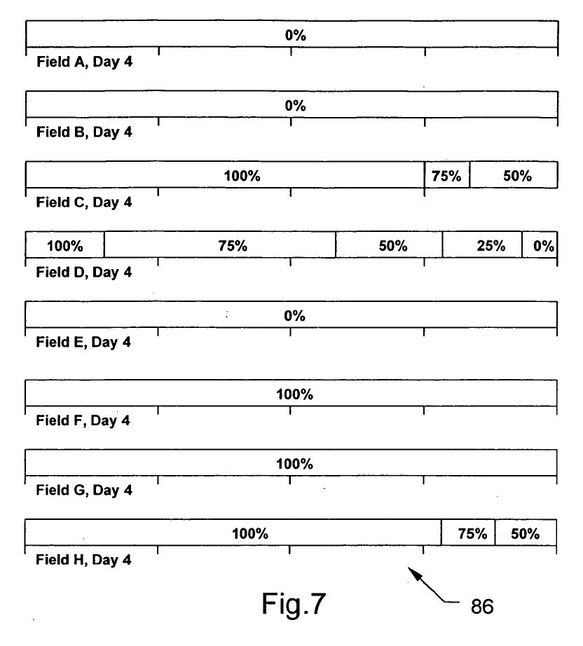

Values for operation variables 8, operation variable suitability 6′, and overall node suitability 6 generated from the foregoing method are available for display 80 in numerous forms. FIG. 5 shows an example of a map display 80 showing overall node suitability 6 for a soil engaging operation over an entire farm field 10 on a single day. This figure also shows a summary of operation suitability 6 over the entire field 10 in a bar graph 82 at the bottom of the illustration. FIG. 6 shows a similar bar graph display 84 showing overall node suitability 6, but for multiple days in the farm field 10. This display 84 is especially useful when planning the best day for performance of a soil engaging operation. Finally, FIG. 7 illustrates a bar graph display 86 showing overall node suitability 6 for multiple farm fields 10 on a single day. This display 86 is especially useful in selecting alternative fields 10 in which to perform the operation on a given day. It is of interest to note that a field 10 may never be suitable for performance of a particular type of soil engaging operation, given the predicted weather 24 and soil conditions 28. Thus, this method may be used to assess and select alternate operations for performance.

Having described the illustrated embodiments, it will become apparent that various modifications can be made without departing from the scope of the invention as defined in the accompanying claims.

### Assignment

The entire right, title and interest in and to this application and all subject matter disclosed and/or claimed therein, including any and all divisions, continuations, reissues, etc., thereof are, effective as of the date of execution of this application, assigned, transferred, sold and set over by the applicant(s) named herein to Deere & Company, a Delaware corporation having offices at Moline, Ill. 61265, U.S.A., together with all rights to file, and to claim priorities in connection with, corresponding patent applications in any and all foreign countries in the name of Deere & Company or otherwise.

1. A method of predicting an operation characteristic at a field node for different points in time, the characteristic indicating suitability for performance of a soil engaging operation, the method comprising the steps of:
accessing values predicted for one or more soil condition at the node;
selecting a predefined soil profile representative of the node;
selecting a predefined operation profile representative of the operation;
determining values for one or more operation characteristic at the node for different points in time using operation characteristic tables giving values relative to soil conditions, soil profile, and operation profile;
displaying values determined for one or more operation characteristic at the node for different points in time.

2. The method described in claim 1, wherein the operation characteristic is soil compaction impact, soil particle size, tractive efficiency, or fuel consumption.

3. The method described in claim 1, further predicting an operation effect at the field node for different points in time, the effect indicating suitability for performance of a soil engaging operation, the method further comprising the steps of:
determining values for one or more operation effect at the node for different points in time using operation effect tables giving values relative to operation characteristics, soil profile, and operation profile;
displaying values determined for one or more operation effect at the node for different points in time.

4. The method described in claim 3, wherein the operation effect is crop yield impact or fuel expense.

5. A method of predicting an operation characteristic at a field node for different points in time, the characteristic indicating suitability for performance of a soil engaging operation, the method comprising the steps of:
accessing values predicted for one or more soil condition at the node;
selecting a predefined soil profile representative of the node;
determining values for one or more soil characteristic at the node for different points in time using soil characteristic tables giving values relative to soil conditions and soil profile;
selecting a predefined operation profile representative of the operation;
determining values for one or more operation characteristic at the node for different points in time using operation characteristic tables giving values relative to soil characteristics, soil profile, and operation profile;
displaying values determined for one or more operation characteristic at the node for different points in time.

6. The method described in claim 5, further comprising the step of displaying values determined for one or more soil characteristic at the node for different points in time

7. The method described in claim 5, wherein the operation characteristic is soil compaction impact, soil particle size, tractive efficiency, or fuel consumption.

8. The method described in claim 5, wherein the soil characteristic is soil Atterberg Limits.

9. The method described in claim 5, further predicting an operation effect at the field node for different points in time, the effect indicating suitability for performance of a soil engaging operation, the method further comprising the steps of:
determining values for one or more operation effect at the node for different points in time using operation effect tables giving values relative to operation characteristics, soil profile, and operation profile;
displaying values determined for one or more operation effect at the node for different points in time.

10. The method described in claim 9, wherein the operation effect is crop yield impact or fuel expense.

11. A method of predicting suitability for performance of a soil engaging operation at a field node for different points in time, the method comprising the steps of:
accessing predicted values for one or more operation variable at the node for different points in time;
selecting suitability parameters for each operation variable;
determining values for operation suitability at the node for different points in time using a suitability algorithm adapted to calculate values by comparing predicted operation variable values against the corresponding suitability parameters;
displaying values determined for operation suitability at the node for different points in time.

12. The method described in claim 11, wherein the operation variable is a weather condition, a soil condition, a soil characteristic, an operation characteristic, or an operation effect.

13. The method described in claim 11, wherein the operation suitability value for one or more field nodes is displayed in a table, graph, or map.

14. The method described in claim 11, wherein an operation variable value for one or more field nodes is displayed in a table, graph, or map.
